(19) United States
(12) Patent Application Publication
(10) Pub. No.: US 2006/0143654 A1
(43) Pub. Date: Jun. 29, 2006

(54) Video display device, video signal output device and channel selection method for video display device

(75) Inventor: Kiyoshi Mochiduki, Chofu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/302,364

(22) Filed: Dec. 14, 2005

(30) Foreign Application Priority Data
Dec. 28, 2004 (JP) 2004-381094

(51) Int. Cl. H04N 5/445; G06F 13/00; G06F 3/00

(52) U.S. Cl. 725/46; 725/45

(57) ABSTRACT

A video display device comprising a display unit, a registration section configured to register a user's favorite category, an extraction section configured to extract information to provide a program of the favorite category registered in the registration section from an electronic program table provided through a broadcast wave, a creation section configured to create distribution information of stream videos relating to the favorite category registered in the registration section among stream videos distributed through a multi-purpose network, and a channel switching section for sequentially switching to display a program included in the information to provide the program and the stream videos included in the distribution information onto the display unit when an operation to request viewing of the favorite category is applied.

### CROSS-REFERENCE TO RELATED APPLICATIONS

This application is based upon and claims the benefit of priority from prior Japanese Patent Application No. 2004-381094, filed Dec. 28, 2004, the entire contents of which are incorporated herein by reference.

### BACKGROUND OF THE INVENTION

1. Field of the Invention

The present invention relates to a video display device, a video signal output device, and a channel selection method for the video display device appropriate for use in a digital television broadcast receiver or the like.

2. Description of the Related Art

As is well known, in recent years, digitalization of a television broadcast has been promoted. For example, in Japan, not only a broadcasting satellite (BS) digital broadcast and 110-degree communication satellite (CS) digital broadcast but also a terrestrial digital broadcast has been started. In such a digital television broadcast system, electronic program guide (EPG) information is multiplexed on a broadcast signal and provided. A digital broadcast receiver extracts an electronic program table from the EPG information. The program table is displayed onto a screen of the broadcast receiver. A user can select a desired program from the program table to view the program and make a recording reservation therefor.

By using the EPG information, the broadcast receiver can provide a variety of useful functions. For example, a function of easily tuning a program the user wants to view is provided by registering a viewing category matching to a user's taste (favorite category) in advance is disclosed (for example, Jpn. Pat. Appln. KOKAI Publishing No. 2001-268467).

In recent years, a video distribution service via a multi-purpose network such as Internet has been started. A concept of the EPG information has already established in a terrestrial broadcast service and a satellite broadcast service, but a concept has not been wholly established in a network distribution service. A variety of distributors and service patterns of network programs make it difficult for the network distribution service to be treated in unity with an existing video broadcast system. A situation in a favorite category retrieval function goes same and a device capable of providing a channel selection function for a favorite category together with the network distribution service has not been known yet.

### BRIEF SUMMARY OF THE INVENTION

According to an aspect of the present invention, there is provided a video display device comprising a display unit; a registration section configured to register a user's favorite category; an extraction section configured to extract information to provide a program of the favorite category registered in the registration section from an electronic program table provided through a broadcast wave; a creation section configured to create distribution information of stream videos relating to the favorite category registered in the registration section among stream videos distributed through a multi-purpose network; and a channel switching section for sequentially switching to display a program included in the information to provide the program and the stream videos included in the distribution information onto the display unit when an operation to request viewing of the favorite category is applied.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary system view showing an embodiment of a broadcast system using a video display device regarding the present invention;

FIG. 2 is a view schematically showing an external appearance of a television set (hereinafter, referred to as TV set) 700 in FIG. 1 and an example of a network system configured around the TV set 700;

FIG. 3 is a view showing a principal signal processing system of the TV set in FIG. 1 and FIG. 2;

FIG. 4 is an exemplary functional block diagram showing a functional configuration of a control unit 61 in FIG. 3;

FIG. 5 is an exemplary flowchart showing processing procedures of the control unit 61 to acquire favorite program information from EPG information;

FIG. 6 is an exemplary flowchart showing processing procedures of the control unit 61 to acquire favorite program information from stream videos distributed via a network;

FIG. 7 is a first flowchart showing processing procedures of the control unit 61 when a user operates to request viewing of a favorite category;

FIG. 8 is a second flowchart showing the processing procedures of the control unit 61 when the user operates to request the viewing of the favorite category; and

FIG. 9 is a third flowchart showing the processing procedures of the control unit 61 when the user operates to request the viewing of the favorite category.

### DETAILED DESCRIPTION OF THE INVENTION

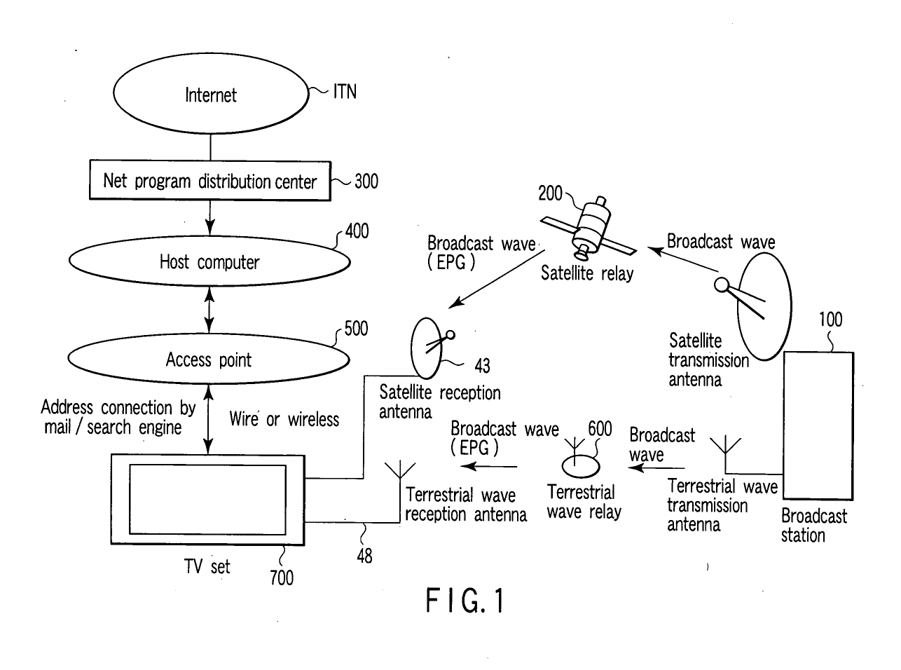

FIG. 1 is the exemplary system view showing the embodiment of the broadcast system using the video display device regarding the present invention. In FIG. 1, a numeral 700 indicates a digital television broadcast receiver being the video display device regarding the present invention and referred to as a TV set 700. The TV set 700 is connected to a terrestrial wave reception antenna 48 and a satellite wave reception antenna 43 and further provided with a connection interface to the Internet INT with a wire or wirelessly. Like this, the TV set 700 is connected to a plurality of video sources and can view videos provided from any video source.

A terrestrial wave transmitted from a broadcast station 100 via a terrestrial wave transmission antenna reaches a terrestrial wave reception antenna 48 of the TV set 700 via a terrestrial wave relay 600, etc. Likewise, a satellite wave transmitted from the broadcast station 100 via a satellite transmission antenna reaches the satellite reception antenna 43 of the TV set 700 via a satellite relay 200. Both terrestrial wave and satellite wave include the EPG information, respectively.

On the other hand, the Internet INT is provided with a network program distribution center 300 to distribute stream videos. The distribution center 300 is connected to an access point 500 through a host computer 400. The TV set 700 is connected to the distribution center 300 through the access point 500.

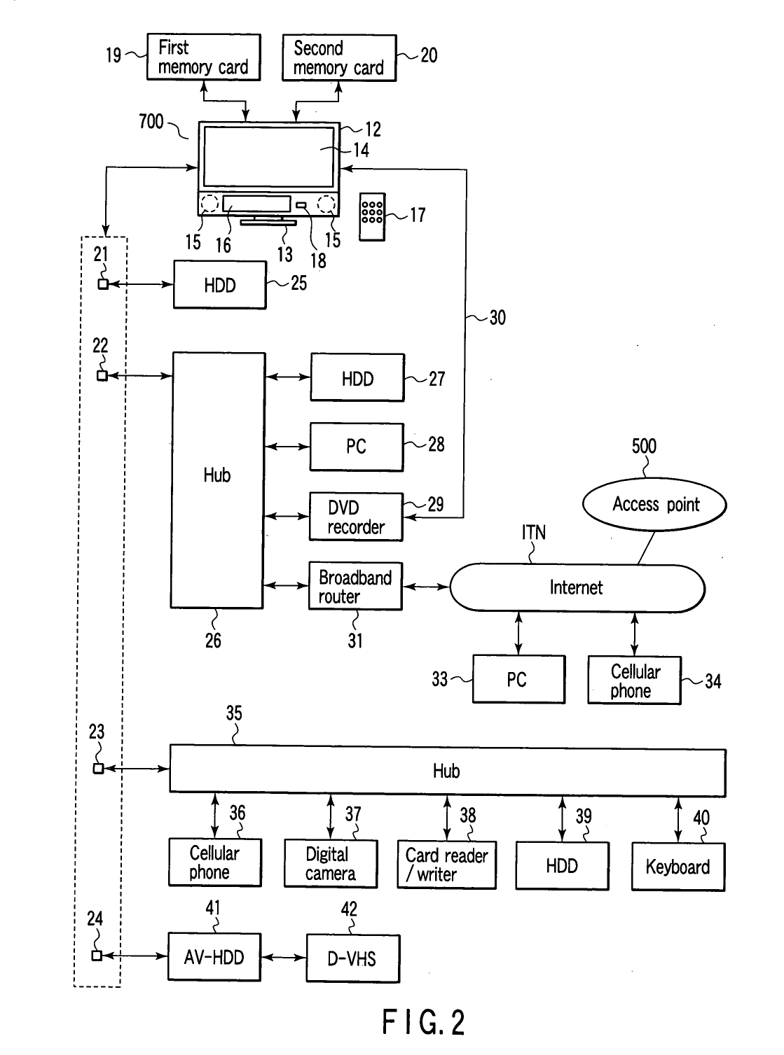

FIG. 2 schematically shows an example of the external appearance of the TV set 700 and a network system configured around the TV set 700. The TV set 700 is composed mainly of a thin cabinet 12 and a support base 13 making the cabinet 12 raised and supported. The cabinet 12 is provided with a flat panel type video display unit 14 composed of a liquid crystal display panel or the kike, a loudspeaker 15, an operation unit 16, and a light receiving unit to receive operation information transmitted from a remote controller 17.

The TV set 700 is adapted to receive a first detachable memory card 19 such as a secure digital (SD) memory card and a multimedia card (MMC). And the TV set 700 performs recording/reproducing of data relating to such as a program or a photograph by using the first memory card 19. The TV set 700 is further adapted to receive a second memory card (IC card) 20 with, for example, contract information recorded thereon and performs recording/reproducing of a variety of items of data to and from the second memory card 20.

The TV set 700 is provided with a first local area network (LAN) terminal 21, a second LAN terminal 22, a universal serial bus (USB) terminal 23 and an i.Link (registered trademark) 24.

Among these parts, the first LAM terminal 21 is used as a LAN-compatible HDD dedicated port. The first LAN terminal 21 is used to record/reproduce information to and from a LAN/compatible HDD 25 being a network attached storage (NAS) through a network [e.g., Ethernet (registered trade mark) network].

As mentioned above, by providing the first LAN terminal 21 to be the LAN-compatible HDD dedicated port, the TV set 700 can stably record information of a program with a high image quality to the HDD 25 without being influenced by other network environment or the status of use of the network.

The second LAN terminal 22 is used as a general LAN-compatible port using the Ethernet. The second LAN terminal 22 is connected to equipment such as, a LAN-compatible HDD 27, a personal computer (PC) 28 and a digital versatile disk (DVD) recorder 29 with a built-in HDD through a hub 26. The second LAN terminal 22 is used to perform information transmissions between these sets of the equipment and the TV set 700.

Digital information communicated through the second LAN terminal 22 is control information for sue in control. Therefore, the DVD recorder 29 utilizes a dedicated analog transmission path 30 to transmit analog information of video and sound to the TV set 700. Furthermore, the second LAN terminal 22 is connected to the Internet ITN via a broadband router 31 connected to the hub 26 and used to communicate information between a PC 33, a cellular phone 34, an access point 500 or the like and the TV set 700 via the Internet ITN.

The USB terminal 23 is used as a general USB-compatible port, and connected to USB equipment such as a cellular phone 36, a digital camera 37, a card reader/writer for a memory card, an HDD 39 and a keyboard 40. The USB terminal 23 is used make information transmissions between these sets of the equipment and the TV set 700. The i.Link terminal 24 serially connects an AV-HDD 41, a digital (D)-video home system (VHS) 42, etc., and supports information transmissions between these sets of the equipment and the TV set 700.

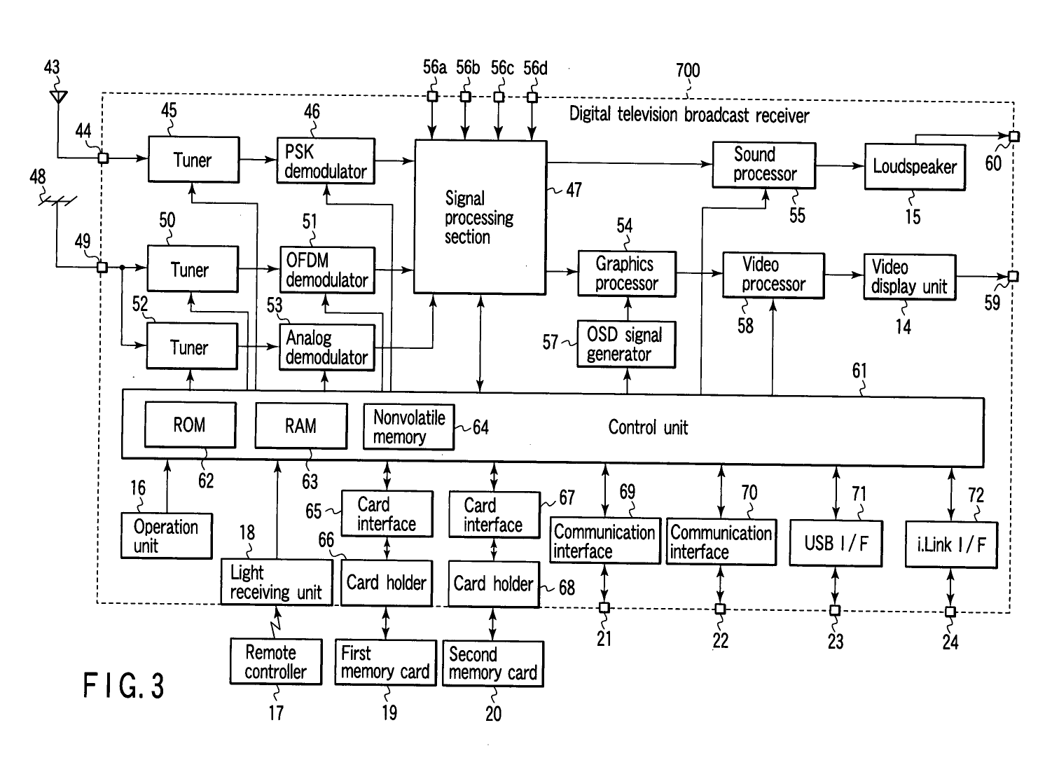

FIG. 3 shows the principal signal processing system of the foregoing TV set 700. A satellite digital television broadcast signal, reached a satellite reception antenna 43 for BS/CS digital broadcast, is supplied to a tuner 45 for satellite digital broadcast through an input terminal 44, and the tuner 45 tunes a broadcast signal of a desired channel. The broadcast signal tuned by the tuner 45 is fed to a phase shift keying (PSK) demodulator 46 to be demodulated into a digital video signal and a digital sound signal, which are output to a signal processor 47. A terrestrial digital television broadcast signal, reached a terrestrial wave reception antenna 48 for receiving terrestrial broadcast, is supplied to a tuner 50 for terrestrial digital broadcast via an input terminal 49. The tuner 50 tunes the broadcast signal of the desired channel.

The broadcast signal tuned by the tuner 50 is supplied to an orthogonal frequency division multiplexing (OFDM) demodulator 51 to be demodulated into a digital video signal and a digital sound signal then output to the signal processor 47. And a terrestrial analog television broadcast signal, received by the terrestrial wave reception antenna 48, is supplied to a tuner 52 for terrestrial analog broadcast via the input terminal 49. The tuner 52 tunes the broadcast signal of the desired channel. The broadcast signal tuned by the tuner 52 is supplied to an analog demodulator 53 to be demodulated into an analog video signal and an analog sound signal then output to the signal processor 47.

The signal processor 47 selectively conducts prescribed digital signal processing of the digital video signals and sound signals supplied from the PSK demodulator 46 and from the OFDM demodulator 51 to output them to a graphic processor 54 and a sound processor 55. The signal processor 47 is connected to a plurality of (four in FIG. 2) input terminals 56a, 56b, 56c and 56d. These input terminals 56a-56d are possible to input the analog video signal and sound signal from the outside of the TV set 700, respectively.

The signal processor 47 selectively conducts digitalization of the analog video signal and sound signal respectively supplied from the analog demodulator 53 and each input terminal 56a-56d, respectively analog demodulator 53 and each input terminal 56a-56d. The signal processor 47 further conducts prescribed digital signal processing of the digitalized video signals and analog signals and outputs output signals to a graphic processor 54 and a sound processor 55, respectively.

The graphic processor 54 superimposes an on screen display (OSD) signal generated from an OSD signal generator 57 on the digital video signal supplied from the signal processor 47. The graphic processor 54 selectively outputs the video signal output from the signal processor 47 and the OSD signal output from the signal generator 57 and also can combine to output both outputs so that both outputs configure a half of a screen, respectively.

The digital video signal output from the graphic processor 54 is supplied to a video processor 58. The video processor 58 converts the input digital video signal into an analog signal in a format possible to be displayed on the video display unit 14 to produce a video display, and also derives the converted signal outside though an output terminal 59. The sound processor 55 converts the input digital sound signal into an analog sound signal in a format that can be reproduced by the loudspeaker 15 and outputs the analog sound signal to the loudspeaker to make a sound reproduction, and also derives the converted signal outside through an output terminal 60.

A control unit 61 integrally controls the whole operations including the above-mentioned various types of receiving operations. The control unit 61 has a built-in central processing unit (CPU) or the like. The control unit 61 receives operation information from the operation unit 16 or receives operation information transmitted from the remote controller 17 through the light receiving unit 18 to respectively control each part so as to reflect operation contents thereto.

The control unit 61 is provided with a read only memory (ROM) 62 with a control program to be executed by a CPU stored thereon, a random access memory (RAM) 63 to provide an operation area and a nonvolatile memory 64 in which a variety of items of setting information and control information are stored.

The control unit 61 is connected to a card holder 66, to which the first memory card 19 can be attached, though a card interface 65. Thereby, the control unit 61 can communicate with the first memory card 19 attached to the card holder 66, through the card interface 65. The control unit 61 is connected to a card holder 68, to which the second memory card 20 can be attached, through a card interface 67. Thereby, the control unit 61 can communicate with the second memory card 20 attached to the card holder 68, through the card interface 67.

The control unit 61 is connected to a first LAN terminal 21 through a communication interface 69. Thereby, the control unit 61 is adapted to support the exchange of information transmissions with the LAN-compatible HDD 25 connected to the first LAN terminal 21 via the card interface 69. In this case, the control unit 61 has a dynamic host configuration protocol (DHCP) server function and assigns an internet protocol (IP) address to the LAN-compatible HDD 25 connected to the first LAN terminal 21 so as to control the HDD 25.

The control unit 61 is further connected to the second LAN terminal 22 through a communication interface 70. The control unit 61 thereby can communicate with any equipment (refer to FIG. 2) connected to the second LAN terminal 22 through the communication interface 70. Furthermore, the control unit 61 is connected to the USB terminal 23 through a USB interface 71. The control unit 61 thereby can communicate with any equipment (refer to FIG. 2) connected to the USB terminal 23 through the USB interface 71. Furthermore, the control unit 61 is connected the i.Link terminal 24 through an i.Link interface 72. Thereby, the control unit 61 can communicate with any equipment (refer to FIG. 2) connected to the i.Link terminal 24 through the i.Link interface 72.

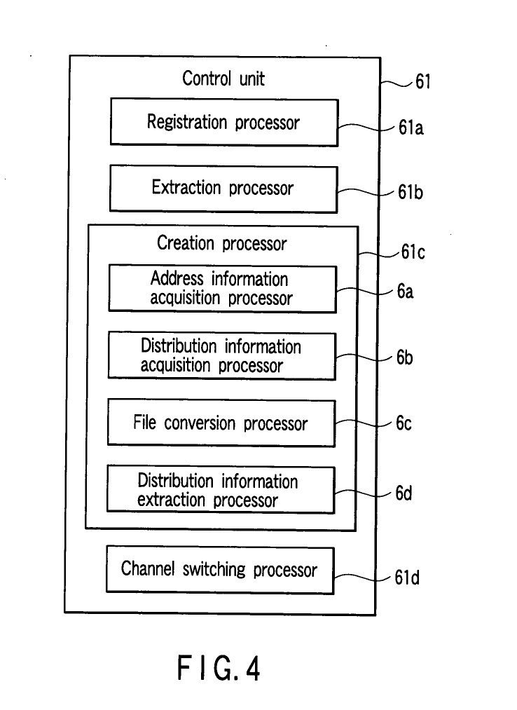

FIG. 4 is a functional block diagram of the control unit 31 in FIG. 3. In FIG. 4, the control unit 61 has a registration processor 61a, an extraction processor 61b, a creation processor 61c and a channel switching processor 61d. The registration processor 61a is a software function to register user's favorite category in advance. Registered information is stored in the nonvolatile memory 64.

The extraction processor 61b is a software function to extract information providing the program of the user's favorite category from the EPG information provided via the terrestrial wave and the satellite wave. The information to provide the program includes information such as presence or absence of a favorite program, a broadcast date and time and a broadcast content. The creation processor 61c is a software function to create distribution information of stream videos of the user's favorite category among stream videos distributed though the Internet ITN. The distribution information also includes such as presence or absence of the favorite program, a broadcast date and time and a broadcast content.

The channel switching processor 61d is a software function to sequentially switch and display programs included in the information to provide the programs (terrestrial broadcast and satellite broadcast) and stream videos included in distribution information (network distribution program) onto the video display unit 14.

In FIG. 4, the creation processor 61c further has an address information acquisition processor 6a, a distribution information acquisition processor 6b, a file conversion processor 6c and a distribution information extraction processor 6d. These processors 6a-6d are realized as, for example, sub-routines to be patched to a control program. The address information acquisition processor 6a is a software function to acquire address information [uniform resource locater (URL)] about the network program distribution center 300 to distribute the stream videos of the user's favorite category by retrieving the Internet ITN by using a search engine or the like.

The distribution information acquisition processor 6b is a software function to access to the distribution center 300 corresponding to the acquired URL and to acquire distribution information of the stream videos relating to the user's favorite category. The distribution information extraction processor 6d is a software function to extract the distribution information of the stream videos of the user's favorite category through a mail magazine if the information to provide the program is provided through the mail magazine from the distribution center 300.

The file conversion processor 6c is a function to convert a data file into, for example, a text form (*.txt), when the distribution information or the mail magazine is distributed by the data file in, for example, an HTML form (*.html). By using a text-based file, the distribution information extraction processor 6d can easily perform keyword retrieval for the distribution information of the stream videos of the user's favorite category.

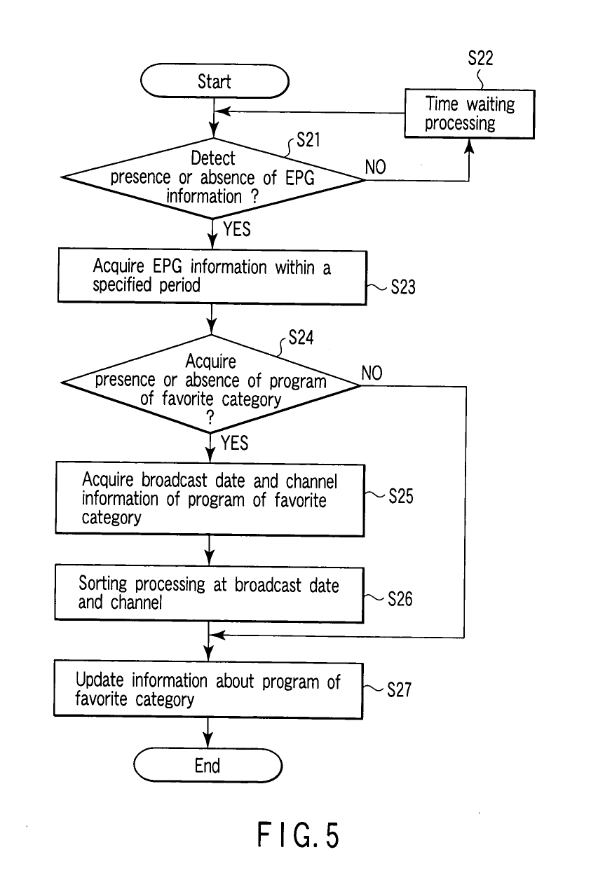

FIG. 5 is a flowchart showing the processing procedures of the control units 61 (in FIG. 3 and FIG. 4) to acquire favorite program information from the EPG information. In FIG. 5, when any channel position of the terrestrial wave and satellite wave with the EPG information added thereto, the control unit 61 periodically confirms the presence or absence of the EPG information and waits until the EPG information can be extracted (steps S21 and S22). The control unit 61 then extracts the EPG information within a period allowed by the TV set 700 into a buffer area of the RAM 63 (step S23).

Next, the control unit 61 calls the favorite category information registered in the TV set 700 in advance by the user from the memory 64. The control unit then retrieves the buffer area to determine whether or not the program, meeting to the favorite category information set by the user, is present in the EPG information (step S24). Even though the control unit 61 retrieves the buffer area, if a program of the favorite category is not present there, the control unit 61 goes through from this processing.

If the program of the favorite category is present in the EPG information, the control unit 61 wholly extracts information such as channel information, a broadcast date and time, a program title and a broadcast content from the EPG information (step S25). Then the control unit 61 sorts the channel information, the broadcast date and time, the program title and the broadcast content of the extracted data in a date order (step S26). When sorting is completed, the control unit 61 stores the sorted data in a memory area to store the favorite category information (step S27).

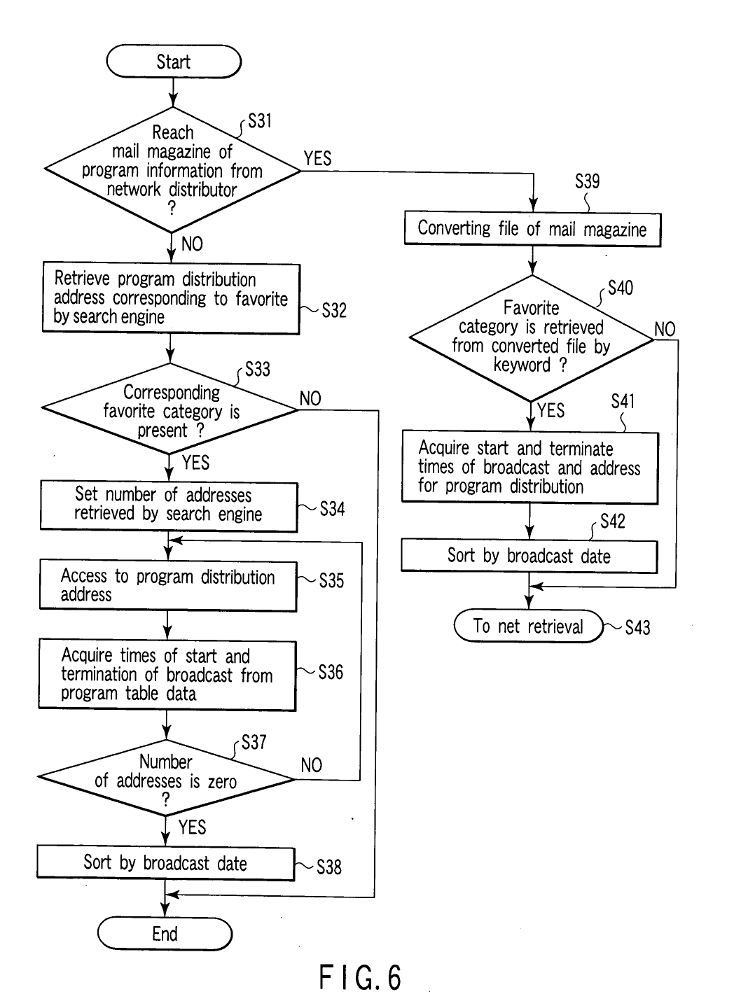

FIG. 6 is flowchart showing the processing procedures of the control units 61 (in FIG. 3 and FIG. 4) to acquire the favorite program information from the stream videos distributed through networks. For acquiring the program information of the stream videos distributed from a network site from the Internet ITN, two methods: a method for directly accessing to a supplying site of a network distribution program; and a method for using the mail magazine, can be taken into consideration.

In FIG. 6, the control unit 61 firstly determines whether or not the program information has already reached from a network distributor through the mail magazine (step S31). If the mail magazine has not reached yet, the control unit 61 retrieves the presence or absence of the site providing the network distribution program matching to the user's favorite category, by using the search engine (step S32). As the result of the retrieval, if the site to provide the desired network distribution program is not present, the control unit 61 goes through the processing.

If the desired network distribution program is present, the control unit 61 accesses to each program providing site in accordance with the address information which has been found by the search engine. After accessing to the program to provide sites, the control unit 61 downloads a program table file provided from the program providing site into the TV set 700. After completion of the download, the control unit 61 converts the program table file into a file form easy to classify in accordance with the broadcast date and time, program title and category.

The control unit 61 retrieves the presence or absence of programs matching to the favorite category information set by the user. As the result of the retrieval, if the program of the favorite category is not present, the control unit 61 goes through the processing. If the desired network distribution programs are present, the control unit 61 extracts the broadcast times, program titles or the like of the matched programs. After extracting the information, the control unit 61 sorts the address information, broadcast dates and times and program titles of the program providing sites in a date order. As soon as completion of the sorting, the control unit 61 stores the data in the memory area to store the favorite category information (steps S33-S37).

If the mail magazine has been distributed (YES, in step S31), the control unit 61 converts the mail magazine into the file in the form easy to classify on the basis of the broadcast dates and times, program titles and categories, etc. (step S39). The control unit 61 performs the keyword retrieval from the file for the presence or absence matching to the favorite category information set by the user (step S40). As the result of the retrieval, if the program of the favorite category is not present, the control unit 61 goes through from the processing to make a shift to network retrieval processing of the step S31 (step S43)

If the programs of the favorite category are present, the control unit 61 extracts the broadcast dates and times, program titles or the like of the programs of the favorite category from the file. After extracting the information, the control unit 61 sorts the address information, broadcast dates and times, program titles of the program providing sites in a date order. As soon as completion of the sorting, the control unit 61 stores the data in the memory area to store the favorite category information.

In an exiting technique, the user can confirms information such as channel positions, program titles, broadcast dates and times, program contents which are matched with the registered favorite categories by means of the video display unit 14. That is, in the foregoing procedures, the conventional technique can be utilized as it is for the technique to select the program information corresponding to the favorite categories and to store only the program information corresponding to the favorite categories in the memory 64.

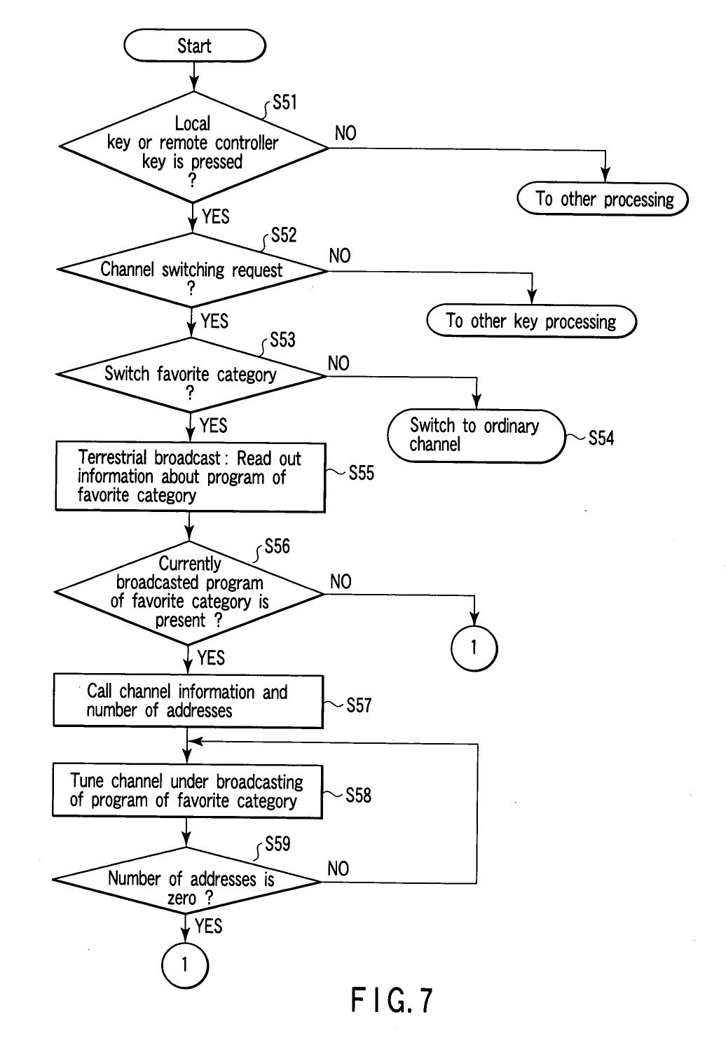

FIG. 7 is a first flowchart showing processing procedures of the control unit 61 when the user operates to require the viewing of the favorite category. In FIG. 7, it is assumed that the user performs an operation to select the favorite category by depressing a local key or by conducting a remote-controlled operation. In the case of tuning in the already registered favorite categories, ordinal tuning processing is conducted (steps S51-S53 and S54). The tuning processing includes up and down tuning and direct tuning. On the other hand, when a favorite category is newly specified, processing procedures in FIG. 5 and FIG. 6 are sequentially conducted. During the acquisition of information necessary for tuning the favorite category, the video display unit 14 (FIG. 3) displays the fact of “retrieval of presence or absence of program of favorite category in progress”.

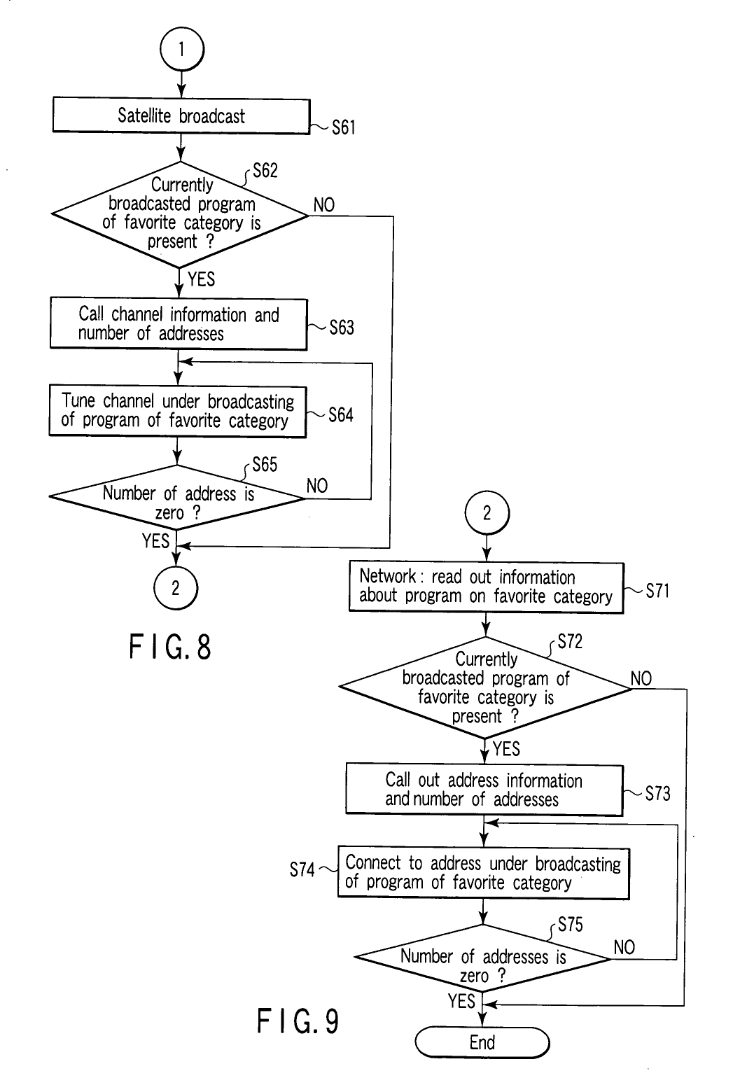

Next, the control unit 61 calls the information about the programs of the favorite category in the terrestrial broadcast from the memory 64 (step S55). The control unit 61 confirms whether or not the program of the desired category is broadcasted in the terrestrial wave (step S56). If the program is not broadcasted, the control unit 61 makes a shift to tuning operations for the satellite wave [(1) in FIG. 8]. If the program of the favorite category is present, the control unit 61 conducts the tuning operations in ascending order of channel positions (step S57-step S59). The cannel positions with programs of the favorite categories not broadcasted therein are skipped.

FIG. 8 is a second flowchart showing processing procedures of the control unit 61 when the user operates to require the viewing of the favorite category. The control unit 61 calls the information about the favorite category in the satellite broadcast from the memory 64 (step S61). Next, the control unit 61 confirms whether or not the program of the user's favorite category is broadcasted in the satellite wave (step S62). If the program is not broadcasted there, the control unit 61 makes a shift to tuning operations by connecting to the site in the network distribution [(2) in FIG. 9]. If the program of the favorite category is broadcasted, the control unit 61 conducts the tuning operations in ascending order of the channel positions (step S63-step S65). The channel positions with specified programs as the favorite categories not broadcasted therein are skipped.

FIG. 9 is a third flowchart showing processing procedures of the control unit 61 when the user operates to require the viewing of the favorite category. The control unit 61 calls the information about the program of the favorite category in the network distribution from the memory 64 (step S71). Next, the control unit 61 confirms whether or not the program of the user's favorite category is distributed through the network distribution (step S72). If the program is not distributed, the control unit 61 terminates the processing to return to a channel position in which the favorite category has not been tuned yet. If the program is distributed, the control unit 61 conducts site connection processing in the order of registered site addresses (step S73-step S75).

In this embodiment as mentioned above, the TV set 700 extracts information about presence or absence of programs, broadcast dates and times, broadcast contents and the like of the programs of the favorite categories form the EPG information acquired from the terrestrial broadcast and the satellite broadcast. Furthermore, the TV set 700 is configured to extract the information about the presence or absence, broadcast dates and times, broadcast contents or the like of the network-distributed programs of the favorite categories by processing the keyword retrieval for the mail magazine.

By the processing described above, the TV set 700 can integrally treat a public broadcast and a network distribution in relation to tuning processing of the favorite category. Accordingly, the TV set 700 can select channels seamlessly for each category in video images provided through a broadcast and a multi-purpose network. Thereby, the video display device, video signal output device and channel selecting method for the video display device, the user convenience of which are enhanced can be provided.

In the conventional technique, data acquisition targets of the favorite categories are limited in systems such as a terrestrial broadcast, a satellite broadcast and a CATV broadcast respectively having the concepts of the EPG information. On the contrary, in this embodiment, the TV set 700 can acquire the data on the favorite category even from the stream videos distributed through the Internet ITN. Thereby, the TV set 700 can perform seamless tuning together with connection to the program providing site through the network in addition to the distributions through the terrestrial wave and satellite wave.

That is to say, according to this embodiment, the distribution information based on the user's favorite category of stream videos distributed through such a multi-purpose network as the Internet is created. In other words, a distribution schedule of video images of the user's favorite category can be created in advance. The TV set 700 can selects the channels seamlessly for each category for the videos provided through the broadcasts and the multi-purpose network.

As described above, according to this embodiment, it becomes to possible to provide a video display device, a video signal output device and a channel selection method for the video display device for enhancing user convenience by channel-selecting videos provided via a broadcast and a multi-purpose network seamlessly for each category.

The present invention is not limited to the forgoing embodiment as it is. For example, in the flowcharts in FIG. 7-FIG. 9, the processing procedures of the order of connection being first the terrestrial broadcast, then the satellite broadcast, and finally the network distribution are shown. However, the order of the tuning is not limited to the order mentioned above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claim and their equivalents.

What is claimed is:

1. A video display device, comprising:
a display unit;
a registration section configured to register a user's favorite category;
an extraction section configured to extract information to provide a program of the favorite category registered in the registration section from an electronic program table provided through a broadcast wave;
a creation section configured to create distribution information of stream videos relating to the favorite category registered in the registration section among stream videos distributed through a multi-purpose network; and
a channel switching section for sequentially switching to display a program included in the information to provide the program and the stream videos included in the distribution information onto the display unit when an operation to request viewing of the favorite category is applied.

2. The video display device according to claim 1, wherein the creation section comprises:
an address information acquisition section configured to acquire address information of a video distribution site to distribute the stream videos of the favorite category registered in the registration section, by retrieving the multi-purpose network; and
a distribution information acquisition section configured to access to the video distribution site on the basis of address information acquired by the address information acquisition section to acquire the distribution information of the stream videos relating to the favorite category.

3. The video display device according to claim 2, wherein
the creation section further comprises a conversion section configured to convert a file form of the distribution information into a text-based file form, and
the extraction section performs keyword retrieval, for the distribution information of the stream videos regarding the favorite category registered in the registration section, from the distribution information of which the file form is converted by the conversion section.

4. The video display device according to claim 1, wherein the creation section comprises a distribution information extraction section configured to extract the distribution information of the stream videos, regarding the favorite category registered in the registration section, from a mail magazine received from the video distribution site of the multi-purpose network.

5. The video display device according to claim 4, wherein
the creation section further comprises a conversion section configured to convert a file form of the mail magazine into a text-based file form, and
the distribution information extraction section performs keyword retrieval for the distribution information of the stream videos regarding the favorite category, form the mail magazine of which the file form is converted by the conversion section.

6. A video signal output device which outputs a video signal to be displayed on a video display unit of a video display device displaying a video onto the display unit, comprising:
a registration section configured to register a user's favorite category;
an extraction section configured to extract information to provide a program of the favorite category registered in the registration section, from an electronic program table provided through a broadcast wave;
a creation section configured to create distribution information of stream videos regarding the favorite category registered in the registration section among stream videos distributed through a multi-purpose network; and
a channel switching section configured to switch sequentially to display a program included in the information to provide the program and the stream videos included in the distribution information when an operation to request viewing of the favorite category is applied.

7. The video signal output device according to claim 6, wherein the creation section comprises:
an address information acquisition section configured to acquire address information of a video distribution site to distribute the stream videos of the favorite category registered in the registration section, by retrieving the multi-purpose network; and
a distribution information acquisition section configured to access to the video distribution site on the basis of address information acquired by the address information acquisition section to acquire the distribution information regarding the stream videos.

8. The video signal output device according to claim 7, wherein
the creation section further comprises a conversion section configured to convert a file form of the distribution information into a text-based file form; and
the extraction section performs keyword retrieval, for the distribution information of the stream videos regarding the favorite category registered in the registration section, from the distribution information of which the file form is converted by the conversion section.

9. The video signal output device according to claim 6, wherein the creation section comprises a distribution information extraction section configured to extract the distribution information of the stream videos regarding the favorite category registered in the registration section, from a mail magazine received from a video distribution site of the multi-purpose network.

10. The video signal output device according to claim 9, wherein
the creation section further comprises a conversion section configured to convert a file form of the mail magazine into a text-based file form, and
the distribution information extraction section performs keyword retrieval, for the distribution information of the stream videos regarding the favorite category, form the mail magazine of which the file form is converted by the conversion section.

11. A channel selection method for use in a video display device for selectively displaying a video, comprising:
a registration step of registering a user's favorite category;
an extraction step of extracting information to provide a program of the favorite category registered in the registration step, from an electronic program table provided through a broadcast wave;
a creation step of creating distribution information of stream videos regarding the favorite category registered in the registration step among stream videos distributed through a multi-purpose network; and
a channel selection step of sequentially switching to display a program included in the information to provide the program and the stream videos included in the distribution information when an operation to request viewing of the favorite category is applied.
